(19) United States
(12) Patent Application Publication
(10) Pub. No.: US 2007/0233555 A1
(43) Pub. Date: Oct. 4, 2007

(54) Personalized Marketing Communications

(75) Inventor: Ludovic Fourrage, Lake Forest Park, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/276,209

(22) Filed: Feb. 17, 2006

(51) Int. Cl. G07G 1/14; G06Q 30/00

(52) U.S. Cl. 705/14

(57) ABSTRACT

Marketing campaigns are personalized to both a sales representative and a customer to achieve better marketing and sales results. A marketing entity identifies a campaign to a sales entity. If the sales entity has customers that would be interested in the campaign, the sales entity nominates customer names to marketing. Campaign communications are designed by marketing instead of by individual sales entities. Communications may be sent to from marketing to the sales entity, where the sales entity has an option of sending the communications to a customer or not, thus enabling the sales entity to tailor a campaign to a customer's needs while maintaining integrity of the campaign context. The communication is shown to originate from the sales entity and is thus more likely to be considered by the customer and not to be disregarded as spam or junk mail.

### BACKGROUND

A problem in most enterprises is that marketing, sales, partners and channels are not tightly integrated. Marketing is typically focused on “breadth” of relationships (i.e. how many potential customers can be reached?) and, as a result, they are not properly equipped to leverage managed relationships their sales force, their partners or their product channels have developed with selected customers. Many marketing entities utilize “blind” communications—reaching out to a massive number of customers with no granular information with regard to the customers' interests—that are sent using third parties or robots as at least a part of a marketing campaign. From a customer's point of view, this results in communications that usually do not resonate with their needs or interests, and therefore is considered as spam and junk email that is ignored by the customer or that is sent directly to a customer's junk email folder.

### SUMMARY

The present description relates to automating personalized sales and marketing communications. Relationships between a sales force and their customers are identified and leveraged so that salespersons can utilize personalized communications created as a part of a marketing campaign. A marketing entity provides a context for a campaign to a sales entity. If the sales entity chooses to subscribe to the marketing campaign, the sales entity nominates customers for the campaign. Marketing campaign elements—such as newsletters, updates, reminders, follow-ups, etc.—are directed to customers from the marketing entity through the sales entity.

The campaign elements are provided to the customers in a manner that suggests that communications have been crafted by and are coming directly from the sales entity, either by routing communications through the sales entity or by sending communications directly to the customer with an indication that the communications came from the sales entity. Each communication may be sent automatically without notice to the sales entity, sent as demanded by the sales entity or sent with notice and a validation option from the sales entity.

Thus, a marketing entity can create communications for a target group and send the communications to a sales entity that maintains relationships with the target group. The sales entity identifies which communications should go to which customers in the target group. As a result, specified customers receive pertinent marketing communications from a trusted source. Customer responses may also be tracked and feedback gathered to improve marketing efforts.

### DESCRIPTION OF THE DRAWINGS

The present description references the following figures.

FIG. 1 is an exemplary prior art marketing model, wherein a marketing unit and a sales unit are within the same enterprise.

FIG. 2 is an exemplary prior art marketing model wherein a marketing unit and a sales unit are part of two distinct enterprises.

FIG. 3 is an exemplary marketing model for providing personalized marketing communications to customers.

FIG. 4 is an exemplary marketing model for providing personalized marketing communications to customers.

FIG. 5 is a block diagram depicting an exemplary system in which the presently described techniques may be implemented.

FIG. 6 is a flow diagram depicting an exemplary methodological implementation of personalized marketing communications.

FIG. 7 is an exemplary computing environment in which the present systems and methods may be implemented.

### DETAILED DESCRIPTION

The present description describes systems, methods and computer-readable media that provide for the creation and distribution of personalized marketing communications. A marketing entity creates a marketing campaign and provides a context for the campaign to a sales entity. This may be done electronically by, for example, e-mail, by conventional mail, or by a combination thereof. It is noted that the marketing entity and the sales entity may belong to a single enterprise or may be a part of separate enterprises. Furthermore, as used herein, an entity may be an organization or a single person.

The sales entity receives the context for the marketing campaign and determines if the sales entity has customers that might be interested in the marketing campaign. If so, the sales entity subscribes to the campaign, thus initiating a process whereby campaign elements will be made available to the sales entity. More particularly, the sales entity provides customer identifiers to the marketing entity to nominate customers for the campaign. The marketing entity is then able to provide marketing communications that are tailored for the nominated customers. Future communications that are a part of the marketing campaign may then be directed to the nominated customers.

An on-demand feature is provided in the event that the sales entity subscribes to a marketing campaign after one or more communications (i.e. campaign elements) have been sent. In this scenario, the sales entity is provided an option to send out the communications that have previously been sent, thus catching customers up on all the communications that have transpired as a part of the marketing campaign.

Since the techniques described herein are designed to exploit an existing relationship between the sales entity and its customers, communications that are sent to customers as a part of a marketing campaign are designed to appear as though they are coming directly from the sales entity, even though the communication actually originated with the marketing entity. Thus, a customer is more likely to accept and review the communication other than viewing it as spam or having the communication go directly to a junk mail folder in the customer's e-mail program.

In most cases, communications will be sent from the marketing entity to the sales entity so that the sales entity can accept or decline the communication for particular customers. Upon accepting a particular communication for a particular customer or a group of customers, the sales entity sends an original transmission of the communication to the customer(s). As a result, the communication comes directly from the sales entity.

In some instances, a communication sent from the marketing entity will include at least two parts. A first part of the communication includes a marketing message that is unalterable by the sales entity. A second part of the communication may be edited by the sales entity to personalize the communication to the sales entity and to the customer.

In at least one implementation described herein, sending the communications is automated to the extent that there are cases where a communication may be sent to one or more customers without explicit approval from sales. For example, a communication may be sent from marketing to sales with an annotation that the communication will be sent to the customer(s) if sales does not respond within a specified period of time.

A priority rating system may also be implemented that assigns a priority to each communication. A low priority communication is one that a sales entity may not need to review to determine to send it to a customer. For example, a monthly newsletter might be a communication that would be expected to be approved for delivery to all customers who have been nominated for a particular campaign. Therefore, a sales entity may not need to approve the newsletter for sending to customers—it will be sent automatically.

Other campaign elements may require a higher priority. For example, if a communication relates to a release of a particular product, a sales entity may desire to decide if the communication is appropriate for the nominated customers. Some customers may not be interested in the particular product or release dates of products. Therefore, a sales entity may need to decline such a communication for one or more customers.

For low priority communications, the marketing entity may transmit the communication directly to the customers. If so, then the marketing entity would transmit the communication while inserting the appropriate sales entity as the sender of the transmission. For higher priority communications that require a hands-on action by the sales entity, the transmission of the communication comes from the sales entity so it naturally will show that it originated with the sales entity.

It is noted that the action of receiving a communication from the marketing entity and sending it to a customer is not a matter of simply forwarding the communication. The communication is transformed in some way, if only to make the communication appear to originate from the sales entity instead of from the marketing entity. In at least one implementation, the communication from the marketing entity to the sales entity is of a first type, and the communication from the sales entity to the customer is of a second type. For example, the communication from the marketing entity might be the announcement of a webcast (an e-mail) while the communication from the sales entity to the customer would be a calendar item, e.g. a meeting request.

The systems and methods described herein also provide a framework for structure feedback to the marketing entity and the sales entity. Customer responses can be tracked to determine top customers, top salespersons, top topics, top geographical areas, etc. Customer actions—such as clicking links and/or articles contained in communications—can be tracked to determine what approaches work best in particular marketing campaigns.

Application of the described techniques results in numerous benefits to all parties involved—the marketing entity, the sales entity and the customers. Sales entities are able to select/subscribe to marketing campaigns that are relevant to their business. A consistency of the marketing message is attained since the marketing entity controls the context of the campaign. Marketers are also able to reach out to a very qualified customer population while avoiding randomizing both the sales entities and their customers. Sales entities will have a better understating of campaign details deliveries, milestones, etc.—and can be more efficient at focusing marketing activities to support their sales efforts with customers. Marketing entities are able to provide better marketing campaigns as a result of improved feedback. Customers perceive the sales entity has having more importance, since important communications that are focused on the customer's interests are coming from the sales entity.

Other benefits are: customers do not receive communications they view as spam; communications have a higher perceived value; customers receive communications in their inbox and not in their junk folder; customers are motivated to response more quickly; customer participation is increased; and customers are more likely to forward communications (i.e. “viral marketing”).

One example of a practical application of the techniques described herein involves a release of a new software product by a software company. The company has a marketing entity that may or may not be a part of the company. The company also has existing sales channels from one or more sales entities to a number of customers. The sales entity may be a sales department within the company, an independent sales organization, a business partner, etc.

Sometime during development of the new software product, the company creates a marketing campaign that touts features of the new product and anticipated availability of the product. The context of the campaign is sent to the sales entity. Sales representatives within the sales entity review the marketing campaign context and determine if they have customers that would be interested in the product.

If, for example, a sales representative has a customer that is an enterprise with a large information technology department and the new software product is a new operating system, the sales representative would determine that the customer may be interested in the campaign and would subscribe to the campaign and nominate the customer.

If, on the other hand, the sales representative has a customer that is a retail outlet specializing in gaming software, the sales representative would determine that the customer would not be interested in the campaign and would not nominate such a customer to receive campaign communications.

As the marketing campaign progresses, communications are sent out directed to nominated customers. The communications may be a periodic publication such as a newsletter, an update as to the status of the release date, a news item regarding the product or a competitor, etc. The communications are personalized to the sales entity and the customer and are sent to the customer. Several ways to accomplish the personalization and sending are described herein.

Other scenarios may involve entities that are not necessarily marketing entities, sales entities and or customers. The terms marketing entity, sales entity and customer are used herein as a matter of convenience to describe certain scenarios and represent virtually any type of entity in the described procedures. The following example illustrates another situation in which the techniques described herein may be used.

Scenario: Wedding Event. A wedding organizer wants to automate and personalize communications to wedding invitees. The types of communications include emails and calendar requests. Examples of communications are: wedding announcement, call for RSVP; wish list available at particular locations; a calendar item for the wedding date; thank you notes; links for photographs; etc.

The content for the communications would be available as a package online and the organizer would subscribe to the service and nominate the invitees. Emails would be sent automatically on behalf of the organizer at moments specified by the organizer.

Similar techniques may be used for other events such as a bachelor party, a graduation ceremony, a pregnancy/birth, and the like.

Other features and benefits of the described systems and methods will be seen in the following discussion as further details of the present subject matter are discussed below. Although the following examples describe the claimed technique in a context of electronic (email) communications, it is noted that any portion of any system or method described herein may be performed by electronic communications, by conventional mail, by other delivery methods, or a combination thereof.

Prior Art Marketing Model: Marketing and Sales in Same Enterprise

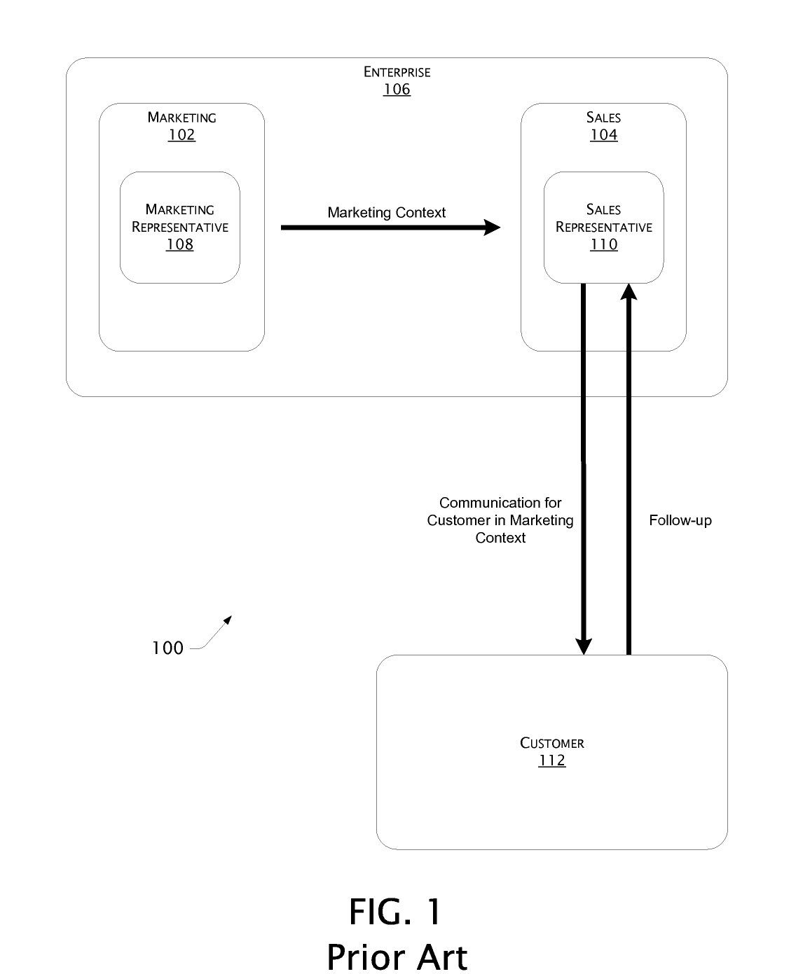

FIG. 1 depicts a prior art marketing model 100 wherein a marketing entity 102 and a sales entity 104 are included in a single enterprise 106. The marketing model 100 illustrates a manner in which communications are handled in previously-known enterprise marketing schemes.

In the marketing model 100 depicted, a marketing representative 108 within the marketing entity 102 provides context for a marketing campaign to a sales representative 110 in the sales entity 104. The sales representative 110 crafts communications designed around the marketing context and provides the communications to a customer 112. Any response the customer has to the communication is made to the sales representative 110.

One issue here is the communication that the sales representative 110 designs. Although the sales representative 110 has been provided a context for the marketing campaign, it is not assured that the communications designed by the sales representative 110 will convey the message that the marketing representative 108 intended.

Another issue is the time involved in creating the communication. In most cases, there will be several customers associated with the sales representative 110 and there will be additional sales representatives associated with additional customers. Under this particular marketing model, the sales representative 110 spends a significant amount of time creating communications for a particular customer. This time is multiplied according to how many sales representatives are involved in the marketing campaign and by how many customers are associated with each sales representative (assuming a unique communication is crafted for each customer).

Furthermore, the sales representative 110 receives follow-up from the customer and can use even a simple response as feedback to some degree. However, unless the communications are somewhat sophisticated in design, the degree of feedback drawn from the customer's response will be small if not negligible. In addition, the marketing representative 108 does not receive feedback from the customer 112.

Prior Art Marketing Model: Marketing and Sales Separate

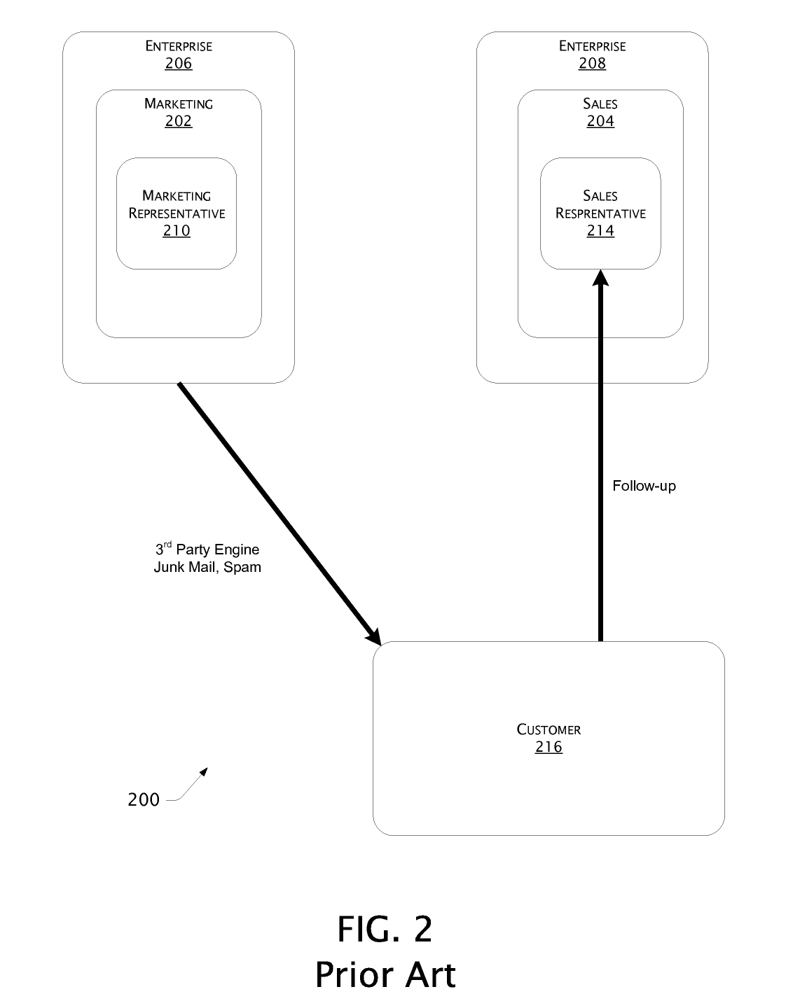

FIG. 2 depicts a prior art marketing model 200 wherein a marketing entity 202 and a sales entity 204 are included in separate enterprises, Enterprise A 206 and Enterprise B 208. In this model, a marketing representative 210 sends communications regarding a marketing campaign directly to a customer 212 (in place of or in addition to the actions associated with the marketing model 100 previously discussed). If the customer wants to respond to the communications, the customer 212 follows up with a sales representative 214 of the sales entity 204.

An additional problem seen with this particular marketing model 200 is that the marketing entity 202 has no way of personalizing the communications. Even if customers can be identified as individual persons and the communications are addressed to these individuals, the communications are sent from the enterprise (Enterprise A 206) or a third party (not shown). As such, the communications may be viewed by the customer 212 as spam or junk mail.

The communications—if identified as junk mail—will be sent directly to ajunk mail folder maintained by a customer e-mail application. If the communications are not sent to ajunk mail folder, they still may never be viewed by the customer 212 since it appears to be an unsolicited mass-mailing from a large enterprise. As a result, the marketing message may never reach the customer 212.

Marketing Model: Personalized Marketing Communications

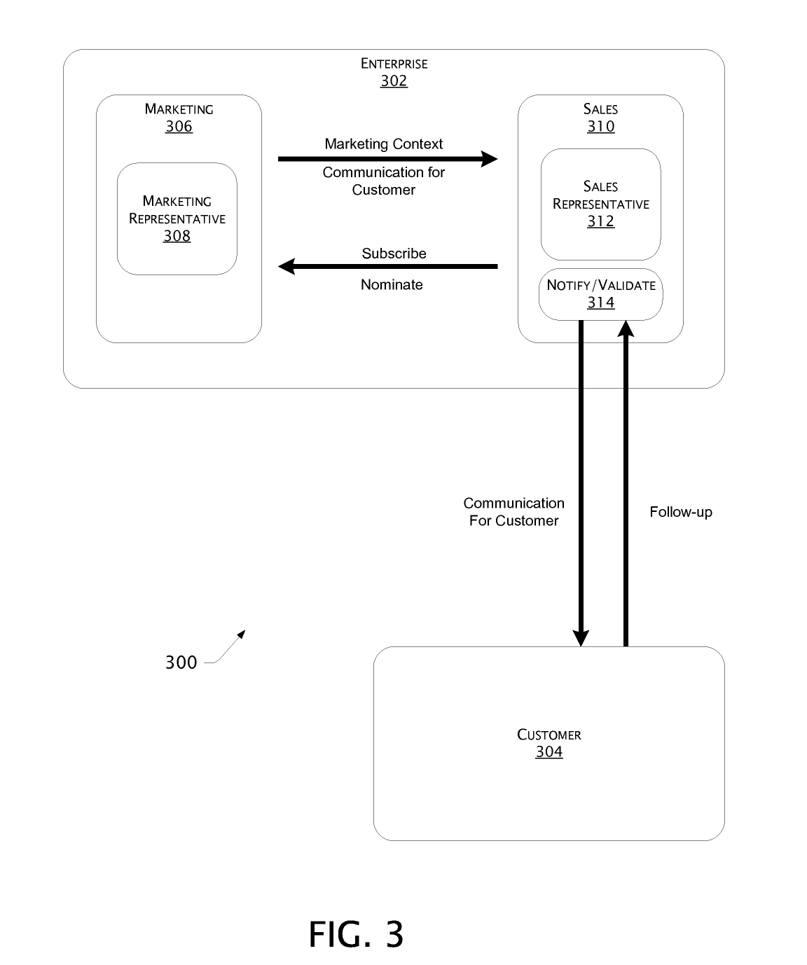

FIG. 3 is a depiction of an exemplary marketing model 300 that provides for personalized marketing communications. The marketing model 300 includes an enterprise 302 that interacts with a customer 304. The enterprise 302 includes a marketing entity 306 that includes at least a marketing representative 308. The enterprise 302 also includes a sales entity 310 that includes at least a sales representative 312.

The marketing entity 306 produces marketing context for a marketing campaign and relates this context to the sales entity 310. In addition to the marketing context, the marketing entity 306 also provides marketing communications for customers 304. All marketing communications associated with a marketing campaign may not be immediately available at the time the marketing context is provided to the sales entity 310. However, in most cases types of communications that will be forthcoming during the marketing campaign (e.g. newsletters, announcements, etc.) can be provided together with at least an initial communication that can be sent from the sales entity 310 to the customer 304.

When viewed in the context of scale, it is apparent how creating customer communications at the marketing entity 306 saves redundant overhead since each sales representative 312 does not have to create their own communications. Also, since the marketing entity 306 created the marketing campaign, it is more likely that marketing communications created by the marketing entity 306 will remain true to the original marketing vision.

After receiving the marketing context, the sales representative 312 can determine particular customers 304 that may be interested or may respond favorably to the marketing campaign. The sales representative 312 therefore subscribes to the marketing campaign, thereby indicating to the marketing entity 306 that the sales representative 312 should receive future marketing communications. At the same time or soon thereafter, the sales representative 312 nominates customers 304 that the sales representative 312 thinks will be interested in the marketing campaign.

The sales representative 312 identifies the customers 312 to the marketing entity 306 by a customer identifier, such as a company name or a name of a person within the company. Future marketing communications may be directed toward this customer identifier.

If some time has elapsed between the time a marketing campaign has commenced (i.e. since marketing communications are sent) and the time a customer 304 is nominated, the sales representative 312 has an on-demand option of requesting previously issued communications to be sent to the customer 304. In one particular implementation, the sales representative 312 is notified via a user interface that one or more communications have already issued and the sales representative 312 is given an opportunity to identify particular communications to send to the new nominees.

When a marketing communication is sent from the marketing entity 306, it is sent to the sales entity 310 but is ultimately destined for the customer 304. To exploit the personal relationship that the sales representative 312 has with the customer 304, the communication is ultimately delivered to the customer 304 from the sales representative 312. Actually, the most important concept is name recognition so at a minimum the communication is sent from the marketing entity 306 to the customer 304 showing that the communication is actually coming from the sales representative 302.

There may be certain marketing campaign elements, or types of communications (e.g. a newsletter) that are acceptable to be sent to the customer 304 without first being inspected by the sales representative 312. These are “low touch” communications or “low priority” communications. In at least one implementation, a priority is assigned to each campaign element. A campaign element with a low priority is a campaign element that does not require intervention by the sales representative 312. Communications related to those campaign elements can be sent directly from marketing to the customer.

However, in most instances, communications will be sent first to the sales entity 310 or sales representative 312. The sales representative 312 is thus notified that the communication is available to be sent to the customer 304 and the sales representative 312 then has an opportunity to accept or deny the communication for each particular customer or group of customers (Notify/Validate 314).

It is noted that the communication is not merely forwarded by sales entity 310 to the customer 304. In at least one scenario, a communication between marketing 306 and sales 310 is of one type (e.g. an e-mail message) and a communication between sales 310 and the customer 304 is of a different type. For example, if the campaign element is a webcast, the communication from marketing 308 to sales 310 may be an e-mail message announcing the webcast. The communication from sales 310 to the customer 312 may be an invitation to join the meeting (i.e. an invitation or calendar event).

In another scenario, the communication from marketing 306 to sales 310 may be an e-mail that includes an attached file, which is the communication that is to be sent to the customer 304. A utility allows the sales representative 312 to open the attached file and indicate which customers (from the customers nominated for this campaign) should receive the communication. The communication is then transmitted to those particular customers. The communication may be such that it may be modified by the sales representative 312 to better suit the customer 304.

Also, a “From” field in an electronic communication should identify the sales representative 312. This is meant to take advantage of the fact that the customer 304 knows the sales representative 312 and the name recognition will lead to the customer 304 paying greater attention to the communication. Over time, the customer 304 will learn that marketing communications from the sales representative 312 can be trusted to be relevant to the business of the customer 304.

A customer 304 may follow up with the sales representative in response to a marketing communication. The sales entity 310 and the marketing entity 308 can utilize the follow-up from the customer to track successful marketing strategies. Such tracking is discussed in greater detail below.

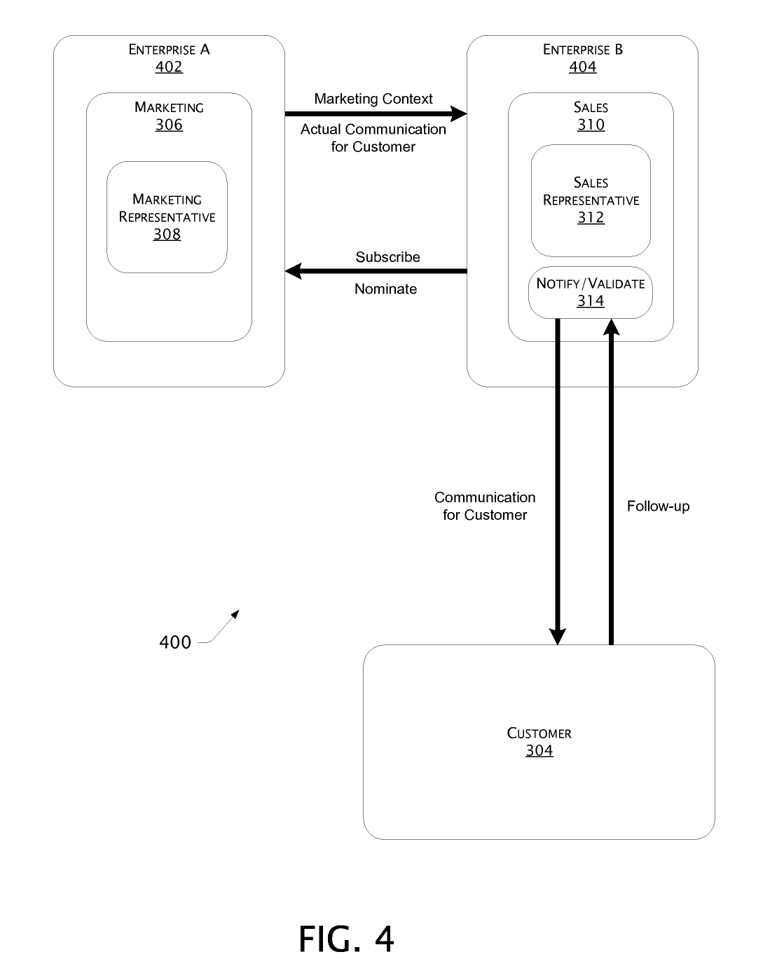

FIG. 4 is a depiction of an exemplary marketing model 400 that provides for personalized marketing communications. The marketing model 400 is similar to the marketing model 300 shown in FIG. 3 and similar elements are marked with similar reference numerals. The difference in the marketing model 300 shown in FIG. 3 and the marketing model 400 depicted in FIG. 4 is that the marketing entity 306 and the sales entity 310 are located in separate entities. Specifically, the marketing entity 306 is situated within Enterprise A 402 and the sales entity 310 is located in Enterprise B 404.

The marketing models 300, 400 work similarly but an advantage realized with the marketing model 400 used with separate entities is that Enterprise B 404 is typically a partner of Enterprise A 402 in an established marketing channel. The sales entity 312 of Enterprise B 404 will realize a cost savings associated with doing business with Enterprise A 402 since the marketing campaigns are provided with marketing communications and require less overhead on the part of the sales entity 312. Therefore, Enterprise A 402 will be naturally be a favored partner of Enterprise B 404.

The previously described features will be discussed in greater detail below, with respect to exemplary systems and methodological implementations. Continuing reference to certain terminology and reference numbers used in previous figures may be used in the following discussion.

Exemplary System for Personalizing Marketing Communications

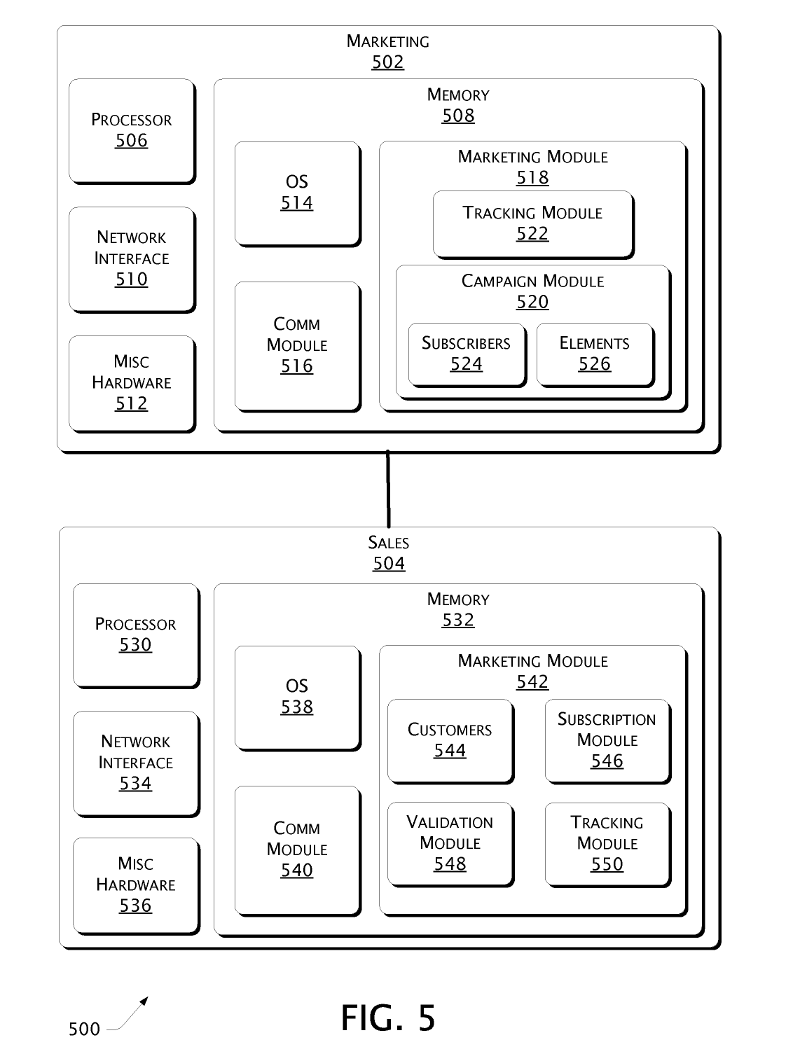

FIG. 5 is a block diagram depicting an exemplary system 500 on which the presently described techniques may be implemented. Although the exemplary system 500 is depicting as one or more computing systems, it is noted that all or part of the system may be implemented on one or more computing systems and that one or more elements may be implemented manually. It is also noted that although the exemplary system 500 is depicted as being divided into particular elements, other implementations may utilized the same, similar or different elements to accomplish the same functionality described herein. Furthermore, although a particular functionality may be attributed to a particular element in the present example, other implementations may allocate system functionality differently, thus attributing certain functions to different system elements than is shown in FIG. 5.

The exemplary system 500 includes a marketing unit 502 and a sales unit 504, each shown implemented as a computing device. The marketing unit 502 and the sales unit 504 may reside on a single computing device, on separate computing devices within an enterprise (not shown) or on separate computing devices in separate enterprises (not shown).

The marketing unit 502 includes a processor 506, memory 508, and a network interface 510 that enables the marketing unit 502 to communicate with one or more computing devices over one or more networks (not shown). Other miscellaneous hardware 512 is included in the marketing unit 502 and comprises computer hardware components typically found in computing systems and necessary for the routine execution of computing tasks that implement at least some of the functionality of the presently described systems and methods.

The memory 508 stores an operating system 514, a communications module 516 and a marketing module 518. The communications module 516 is configured to enable communications between the marketing unit 502 and the sales unit 504. The communications module 516 may include one or more of the following applications: an e-mail application; an electronic calendar application; a task tracking application; a contacts application; and the like.

The operating system 508 comprises miscellaneous software modules that are required to perform typically computing control tasks as well as advanced computing processing to support the functionality described herein. The marketing module 518 includes a campaign module 520 and a tracking module 522. The campaign module 520 is configured to provide functionality to support functions described herein that are associated with a marketing campaign.

The campaign module 520 further includes a subscribers module 524 and an elements module 526. The subscribers module 524 is configured to support nomination of customers to include in a marketing campaign and to store the nominated customers. The elements module 526 is configured to store campaign elements associated with a campaign and to provide the sales unit 504 with a way in which to see campaign elements that are available on an on-demand basis.

A campaign may have a type associated therewith. Examples of some types of campaigns are a program, an event and a sales incentive. Each type of campaign has certain campaign elements associated with it. For example, a program campaign may have campaign elements of: a nomination; an invitation; a status; a newsletter; a newsflash; and/or the like. An event campaign may include campaign elements of: a nomination; an invitation; a status; a reminder; a follow-up; etc.

Communications are related to campaign elements. For example, an invitation campaign element will have a communication associated with it. A first communication type associated with the invitation will be an e-mail message from the marketing unit 502 to the sales unit 504, informing the sales unit 504 that the invitation is available to send to customers. When the sales unit 504 sends the invitation to a customer, it will be in the form of a second communication type—a calendar event that can be accepted or declined by the customer.

The tracking module 522 is configured to track various action associated with a marketing campaign. Virtually any type of communication can be tracked and used for feedback. For example, the tracking module 522 can track how often particular sales representatives subscribe to campaigns or how many nominees each sales representative typically nominates for a campaign. Further, the tracking module 522 can track the responses to different types of communications (e-mails, calendar events, etc.).

The sales unit 504 includes a processor 530, memory 532, and a network interface 534 that enables the sales unit 504 to communicate with one or more computing devices over one or more networks (not shown). Other miscellaneous hardware 536 is included in the sales unit 502 and comprises computer hardware components typically found in computing systems and necessary for the routine execution of computing tasks that implement at least some of the functionality of the presently described systems and methods.

The memory 532 stores an operating system 538, a communications module 540 and a marketing module 542. The communications module 540 is configured to enable communications between the sales unit 504 and the marketing unit 502. The communications module 540 may include one or more of the following applications: an e-mail application; an electronic calendar application; a task tracking application; a contacts application; and the like.

The operating system 538 comprises miscellaneous software modules that are required to perform typically computing control tasks as well as advanced computing processing to support the functionality described herein. The marketing module 542 includes a customers module 544 and a subscription module 546. The customers module 544 is configures to store names of customers and related information. The subscription module 546 is configured to enable the sales unit 504 to nominate customers to a marketing campaign promulgated by the marketing unit 502.

The marketing module 542 also includes a validation module 548 and a tracking module 550. The validation module 548 is configured to enable the sales unit 504 to accept or deny a communication sent by the marketing unit 502 and intended for ultimate delivery to a customer. The tracking module 550 is configured to track communications and customer responses and to provide feedback to the marketing unit 502.

The tracking module 550 may be configured in any of several ways known in the art. For example, the tracking module may be linked to a clickstream engine (not shown) that enables the tracking module 550 to capture an origin of a click, e.g. which customer, which sales entity, etc.

The elements and the functionality thereof are described in greater detail below, with respect to a flow diagram depicting an exemplary methodological implementation suitable for use with the exemplary system 500 shown and described herein.

Exemplary Methodological Implementation:

Personalizing Marketing Communications

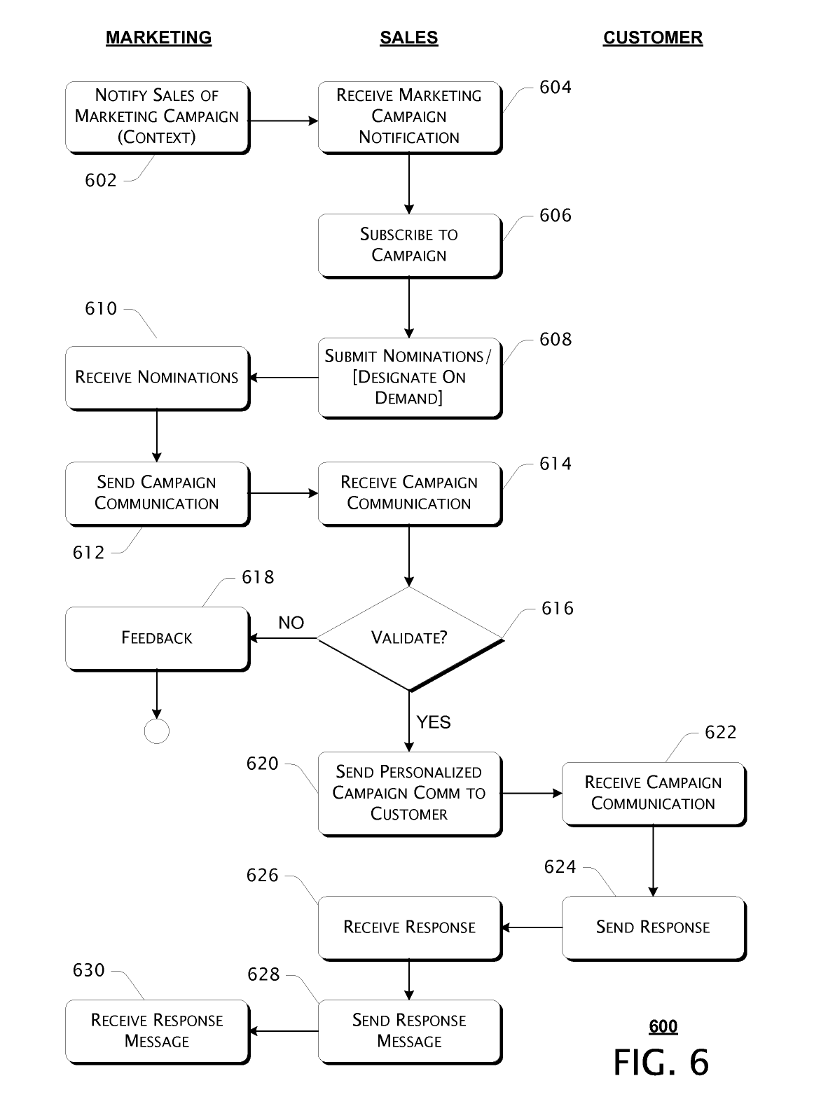

FIG. 6 is a flow diagram 600 depicting an exemplary methodological implementation for personalizing marketing communications. In the discussion of FIG. 6, continuing reference is made to elements and reference numerals shown and described in FIG. 5. It is noted that although the particular method depicted by the flow diagram 600 is shown as having certain steps, the steps may be performed in an alternative order, some steps may be omitted and some steps not described may be added without departing from the scope of the claims appended hereto.

It is noted that this particular implementation is exemplary only and that the presently described subject matter may be implemented in various forms in accordance with the description and the claims. In this particular depiction, blocks of the flow diagram 600 are positioned according to where actions corresponding to the blocks are performed—the marketing entity, the sales entity or the customer.

At block 602, the marketing unit 502 sends a notification to the sales unit 504 that a marketing campaign is available. This notification includes elements that are included in the campaign, such as a newsletter, a reminder, a status report, a newsflash, an invitation, and the like. The sales unit 504 receives the marketing campaign notification at block 604.

The notification describes a context of the marketing campaign. This context may include the subject matter of the campaign, potential customers, active dates of the campaign, etc. The notification provides the sales unit 504 with an interface through which the sales unit 504 can subscribe to the marketing campaign.

The sales unit 504 examines the context of the marketing campaign and determines if any customers associated with the sales unit 504 may be interested in receiving communications regarding the campaign. If there are such customers, the sales unit subscribes to the campaign (block 606). The sales unit 504 nominates customers at block 608.

With a nomination, the sales unit provides a customer identifier to the marketing unit 502 so that the marketing unit 502 can include the customer identifier on communications related to the marketing campaign. The customer identifier can be a company name or a name of an individual. Since a sales representative personally handles business with the customer, the person representing the customer is usually known to the sales representative. Including a person's name on communications helps realize the full potential of the techniques described herein.

There are times in which a sales representative does not subscribe to a campaign immediately upon notification of the campaign. In those instances, a sales representative may subscribe only after one or more campaign communications have been sent out. The sales unit 504 may want to provide these previous communications to the customers that are being nominated. Therefore, the subscription module 546 has an on-demand feature that presents previously issued communications to a sales representative when the representative subscribes to a campaign, nominates additional customers to the campaign, or any other time. The sales representative identifies which communications should go out to which customers that the sales representative has just nominated.

At block 610, the marketing unit 502 receives the nominations provided by the sales unit 504 and a campaign communication is sent by the marketing unit 502 at block 612. The sales unit 504 receives the campaign communication (block (614) so that a sales representative can validate or decline the communication for subsequent transmittal to the customer.

It has been previously noted that a communication may be sent directly to the customer from the marketing unit 502 as long as the communication is personalized to the customer and indicates that the communication originates from the sales unit 504. In this case, there is no validation step performed by the sales unit 504. These situations are rare since they deprive a sales representative of an opportunity to strictly tailor the campaign for each customer. However, these situations only occur for communications that would rarely be declined by the sales representative. A newsletter is an example of a communication that might automatically go to the customer without explicit validation from the sales unit 504.

In at least one implementation, a passive validation scheme is used. In such a scheme, the sales unit 504 is informed that a particular communication will be sent to the customer after a certain amount of time has elapsed unless the sales unit 504 explicitly declines the communication. In this scheme, if a sales representative happens to neglect a communication validation, the communication will be sent regardless.

If the sales unit 504 declines to validate the communication (“No” branch, block 616), then feedback is submitted to the marketing unit 502 at block 618. Said feedback may merely indicate that the communication was denied. Alternatively, an implementation may provide a feature wherein the sales unit 504 can provide feedback comments to the marketing unit 502.

If the sales unit 504 validates the communication (“Yes” branch, block 616), then the communication is sent to the customer at block 620. This transmittal does not simply forward the communication as it was received from the marketing department. A new e-mail message (or other type of communication) is created by the communications module 540 of the sales unit 504. This ensures that the communication will originate with the sales unit 504 and thus have a greater chance of getting a customer response. Furthermore, the sales unit 504 may modify the communication to better suit the customer's desires while maintaining the integrity of the original intent of the marketing context.

The customer receives the personalized marketing communication at block 622 and may send a response back to the sales unit 504 at block 624. The response may be an order of goods or services, an acceptance of an invitation to a meeting or webcast, a request for additional information, etc.

The sales unit 504 receives the customer response at block 626 and may elect to send a response message to the marketing unit 502 at block 628. If a response message is sent, the marketing unit 502 receives the response message at block 630 and may utilize the response message in a statistical analysis of marketing results for the campaign.

Exemplary Operating Environment

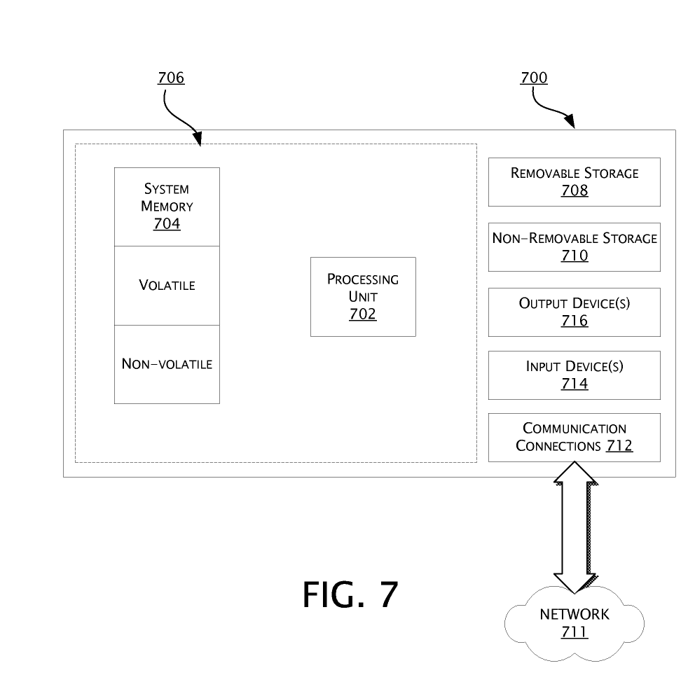

FIG. 7 and the following discussion are intended to provide a brief, general description of a suitable computing environment in which all or a portion of a system and/or method as described herein may be implemented. The operating environment of FIG. 7 is only one example of a suitable operating environment and is not intended to suggest any limitation as to the scope of use or functionality of the operating environment. Other well known computing systems, environments, and/or configurations that may be suitable for use as described herein include, but are not limited to, personal computers, hand-held or laptop devices, multiprocessor systems, micro-processor based systems, programmable consumer electronics, network personal computers, server computers, mini computers, mainframe computers, distributed computing environments that include any of the above systems or devices, and the like.

Although not required, the systems described herein may be described in the general context of computer-executable instructions, such as program modules, being executed by one or more computers or other devices. Generally, program modules include routines, programs, objects, components, data structures, etc., that perform particular tasks or implement particular abstract data types. Typically, the functionality of the program modules may be combined or distributed as desired in various environments. In a distributed environment, program modules may be located in both local and remote computer-storage media including memory-storage devices.

With reference to FIG. 7, an exemplary system for implementing a system as described herein includes a computing device, such as computing device 700. In its most basic configuration, computing device 700 typically includes at least one processing unit 702 and memory 704. Depending on the exact configuration and type of computing device, memory 704 may be volatile (such as RAM), non-volatile (such as ROM, flash memory, etc.) or some combination of the two. This most basic configuration is illustrated in FIG. 7 by dashed line 706. Additionally, device 700 may also have additional features and/or functionality. For example, device 700 may also include additional storage (e.g., removable and/or non-removable) including, but not limited to, magnetic or optical disks or tape. Such additional storage is illustrated in FIG. 7 by removable storage 708 and non-removable storage 710. Computer storage media includes volatile and non-volatile, removable and non-removable media implemented in any method or technology for storage of information such as computer readable instructions, data structures, program modules, or other data. Memory 704, removable storage 708, and non-removable storage 710 are all examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which can be used to store the desired information and which can be accessed by device 700. Any such computer storage media may be part of device 700.

Device 700 may also contain communication connection(s) 712 that allow the device 700 to communicate with other computing devices, such as other nodes within a computing system network 711. Communications connection(s) 712 is an example of communication media. Communication media typically embodies computer readable instructions, data structures or program modules. By way of example, and not limitation, communication media includes wired media such as a wired network or direct-wired connection, and wireless media such as acoustic, radio frequency, infrared, and other wireless media.

Device 700 may also have input device(s) 714 such as keyboard, mouse, pen, voice input device, touch input device, laser range finder, infra-red cameras, video input devices, and/or any other input device. Output device(s) 716 such as display, speakers, printer, and/or any other output device may also be included.

In the description that follows, the present invention is described with reference to acts and symbolic representations of operations that are performed by one or more computing devices, unless indicated otherwise. As such, it will be understood that such acts and operations, which are at times referred to as being computer-executed, include the manipulation by the processing unit of the computing device of electrical signals representing data in a structured form. This manipulation transforms the data or maintains them at locations in the memory system of the computing device, which reconfigures or otherwise alters the operation of the device in a manner well understood by those skilled in the art. While the following description is described in the foregoing context, it is not meant to be limiting as those of skill in the art will appreciate that various of the acts and operations described hereinafter may also be implemented in hardware. For example, by utilizing conventional techniques known to those skilled in the art that all, or a portion of the software instructions may be carried out by a dedicated circuit, such as a DSP, programmable logic array, or the like.

The data structures where data are maintained are physical locations of the memory that have particular properties defined by the format of the data. Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or distributively process by executing some software instructions at the local terminal and some at the remote computer (or computer network).

### CONCLUSION

While exemplary implementations and applications of the code module initialization have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the invention, as both described above and claimed below.

We claim:

1. A method, comprising:
notifying a sales entity of a marketing campaign and a context thereof;
receiving a subscription from the sales entity;
receiving one or more nominations for the marketing campaign from the sales entity, each nomination further comprising a customer identifier for a nominee; and
sending one or more campaign communications associated with the marketing campaign to each nominee in a manner such that it appears to a nominee receiving a campaign communication that the campaign communication originated with the sales entity.

2. The method as recited in claim 1, wherein the sending step further comprises sending one or more campaign communications associated with the marketing campaign to each nominee via the sales entity.

3. The method as recited in claim 2, further comprising configuring the one or more campaign communications so that the sales entity has the option of preventing the campaign communications from being sent to a nominee.

4. The method as recited in claim 1, wherein the sending further comprises sending one or more campaign communications to the sales entity where it is transformed and sent to the one or more nominees.

5. The method as recited in claim 1, wherein the sending further comprises sending the one or more communications to the sales entity to notify the sales entity that the one or more communications have been sent to the one or more nominees.

6. The method as recited in claim 1, wherein:
the sending further comprises sending the at least one communication to the sales entity by way of a first type of communication; and
the communication is sent to a nominee by way of a second type of communication.

7. The method as recited in claim 1, further comprising sending at least one communication to the sales entity with a message stating that the communication will be forwarded to at least one nominee unless declined by the sales entity.

8. The method as recited in claim 1, further comprising tracking interaction of a nominee with a communication after at least one of the one or more communications is received by the nominee.

9. A system, comprising:
a campaign module configured to store one or more campaign elements associated with a marketing campaign and one or more communications each associated with a campaign element;
a subscribers module configured to receive one or more nominations from a sales entity, each nomination identifying a customer associated with the sales entity; and
a marketing module configured to direct a communication to a customer in a manner such that when the customer receives the communication, the communication appears to the customer that the communication originated from the sales entity.

10. The system as recited in claim 9, wherein the subscribers module is further configured to allow the sales entity to initiate an instance of sending a communication on demand.

11. The system as recited in claim 9, wherein the communication is configured so that a first portion of the communication relates to the marketing campaign and is unalterable by the sales entity and a second portion may be edited by the sales entity to personalize the communication.

12. The system as recited in claim 9, wherein the marketing module is further configured to send a communication to a customer and notify the sales entity that the communication has been sent to the customer.

13. The system as recited in claim 9, wherein the marketing module is further configured to send a communication to the sales entity and inform the sales entity that the communication will be sent to a customer unless the sales entity provides an indication that the communication should not be sent to the customer.

14. The system as recited in claim 9, wherein:
the marketing module is further configured to send a communication to the sales entity; the communication being directed to a customer;
the communication further comprises a first type of communication; and
the communication is designed to be transformed by the sales entity into a second type of communication and sent by the sales entity to the customer.

15. The system as recited in claim 9, further comprising a tracking module configured to identify at least one action taken by a customer in response to a communication received by the customer.

16. One or more computer-readable media containing executable instructions that, when executed, implement a method in a sales entity, the method comprising the following steps:
receiving a marketing context from a marketing entity that describes a marketing campaign and campaign elements associated with the marketing campaign;
subscribing to the marketing campaign by providing, for each of one or more customers, a customer identifier associated with a customer so that communications associated with the campaign elements will be sent to the customer in a manner such that the communication will be personalized to appear to originate with the sales entity; and
causing the communications to be sent to the customer.

17. The one or more computer-readable media as recited in claim 16, wherein the causing further comprises:
receiving a communication from the marketing entity;
altering the communication to personalize the communication; and
sending the communication, as altered, to the customer.

18. The one or more computer-readable media as recited in claim 17, wherein:
the receiving a communication further comprises receiving a first type of communication; and
the sending the communication further comprises sending the communication as a second type of communication.

19. The one or more computer-readable media as recited in claim 16, wherein the causing further comprises:
receiving a notification from the marketing entity that the communication is available to be sent to the customer; and
validating the communication so that the communication is sent to the customer.

20. The one or more computer-readable media as recited in claim 16, wherein the causing further comprises receiving a notification from the marketing entity that the communication has been sent to the customer.
